(19) United States
(12) Patent Application Publication
(10) Pub. No.: US 2005/0129297 A1
(43) Pub. Date: Jun. 16, 2005

(54) Classification of breast lesion method and system

(76) Inventors: Vidya Pundalik Kamath, (US); Kai Erik Thomenius, Clifton Park, NY (US); Mannan Bakthavathsalu, (US)

Correspondence Address: Patrick S. Yoder;FLETCHER YODER, P.O. Box 692289, Houston, TX, 77269-2289, US

(21) Appl. No.: 10/736,192

(22) Filed: Dec. 15, 2003

(51) Int. Cl. G06K 9/00

(52) U.S. Cl. 382/132

(57) ABSTRACT

An automated method for determining a plurality of characteristics of a breast lesion is provided. The method comprises automatically identifying a region of interest in an image, the region of interest comprising the breast lesion, and preprocessing the region of interest to enhance a quality of the image. The method further comprises automatically segmenting the breast lesion in the region of interest and automatically measuring a plurality of measurements for determining the plurality of characteristics of the breast lesion. The breast lesion is automatically classified as benign or malignant based on the plurality of measurements.

### BACKGROUND OF THE INVENTION

The invention relates to imaging systems and more specifically to a method and apparatus for classification of breast lesions.

Breast cancer is one of the leading causes of death among women. Typically, breast cancer is detected by a method called mammography, generally an X-ray imaging procedure. Mammography has become the standard for detecting and characterizing malignancy. Following image acquisition, a radiologist typically reads the images to discern whether suspicious growths appear, and whether they are likely problematical. However, in recent times ultrasound imaging techniques has shown promise for discriminating cysts from solid masses. Satisfactory techniques for such discrimination are not, however, yet available.

Usually, solid breast masses are hard to distinguish from malignant masses through traditional image-based diagnosis techniques. As a result, patients in which such masses are detected are usually referred for biopsy. Thus, persons with benign lesions may have to undergo unnecessary biopsy in the interests of making a proper diagnosis of malignant growths. It would be desirable, however, to make such diagnoses without the need for surgical intervention.

Ultrasound imaging holds the potential for identifying masses in the breast as benign, avoiding unwanted biopsies. Thus, ultrasound forms an essential link between mammography and biopsy. Besides, ultrasound is recommended for pregnant patients, follow-up patients with fibrocystic diseases, and also is used as guidance mechanism in the biopsy procedures of cyst aspiration.

Certain features that characterize malignant lesions in the ultrasound breast images are fairly well understood. However, the tools and techniques in image processing to extract these features and quantify them for accurate classification are not available for automated implementation, as the tools are manual or semi-automatic because the side lobes, grating lobes, multi path reverberation and coherent wave interference mar the ultrasound imaging. Such images typically have poor spatial resolution, are granular in appearance, and display rich speckle noise content, low contrast, sporadic clutter and spurious echoes. Further such images sometimes mask the features of interest or distort and mislead even a trained observer.

Therefore, there is a need for a system and method for automatically detecting and classifying breast lesions so that persons may avoid undergoing unnecessary biopsies.

### BRIEF DESCRIPTION OF THE INVENTION

Briefly, in accordance with one aspect of the present invention, an automated technique for determining a plurality of characteristics of a breast lesion is provided. The technique comprises automatically identifying a region of interest in an image, the region of interest comprising the breast lesion. The technique further comprises preprocessing the region of interest to enhance a quality of the image, and automatically segmenting the breast lesion in the region of interest. The technique further comprises automatically measuring a plurality of measurements for determining the plurality of characteristics of the breast lesion, and automatically classifying the breast lesion as benign or malignant based on the plurality of measurements.

In a further embodiment, a system for determining a plurality of characteristics of a breast lesion is provided. The system comprises a memory unit configured for storing an image and a processor configured for automatically identifying a region of interest in the image, the region of interest comprising the breast lesion. The processor is further configured for preprocessing the region of interest to enhance a quality of the image, automatically segmenting the breast lesion in the region of interest and automatically measuring a plurality of measurements for determining the plurality of characteristics of the breast lesion. The processor is further configured for automatically classifying the breast lesion as benign or malignant based on the plurality of measurements.

In a further embodiment, a computer-readable medium storing computer instructions for instructing a computer system to determining a plurality of characteristics of a breast lesion is provided. The computer instructions includes automatically identifying a region of interest in an image, the region of interest comprising the breast lesion and preprocessing the region of interest to enhance a quality of the image. The computer instructions further include automatically segmenting the breast lesion in the region of interest, automatically measuring a plurality of measurements for determining the plurality of characteristics of the breast lesion, and automatically classifying the breast lesion as benign or malignant based on the plurality of measurements.

In a further embodiment, a system for determining a plurality of characteristics of a breast lesion is provided. The system comprises means for automatically identifying a region of interest in an image, the region of interest comprising the breast lesion and means for preprocessing the region of interest to enhance a quality of the image. The system further includes means for automatically segmenting the breast lesion in the region of interest, means for automatically measuring a plurality of measurements for determining the plurality of characteristics of the breast lesion, and means for automatically classifying the breast lesion as benign or malignant based on the plurality of measurements.

### BRIEF DESCRIPTION OF THE DRAWINGS

The foregoing and other advantages and features of the invention will become apparent upon reading the following detailed description and upon reference to the drawings in which:

FIG. 1 is an exemplary embodiment of an ultrasound system implemented in accordance with the present invention;

FIG. 2 is a flow chart illustrating automated method for determining a plurality of characteristics of a breast lesion;

FIG. 3 is a diagram illustrating a measurement of aspect ratio according to one aspect of the invention;

FIG. 4 is a diagram illustrating a measurement of regularity of a lesion boundary according to one aspect of the invention;

FIG. 5 is a diagram illustrating a measurement of compactness of the lesion according to one aspect of the invention; and

FIG. 6 is a diagram illustrating a posterior echo measurement according to one aspect of the invention

### DETAILED DESCRIPTION OF SPECIFIC EMBODIMENTS

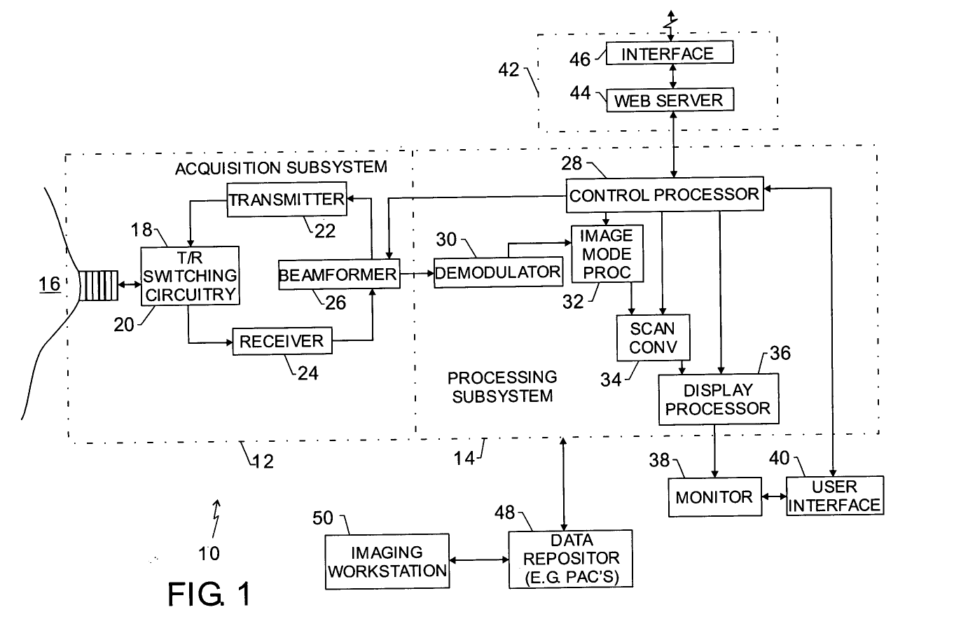

FIG. 1 is a block diagram of an embodiment of an ultrasound system 10 implemented in accordance to one aspect of the invention. The ultrasound system comprises of acquisition subsystem 12 and processing subsystem 14. The acquisition subsystem 12 comprises a transducer array 18 (comprising a plurality of transducer array elements), transmit/receive switching circuitry 20, a transmitter 22, a receiver 24, and a beamformer 26. Processing subsystem 14 comprises a control processor 28, a demodulator 30, an imaging mode processor 32, a scan converter 34 and a display processor 36. The display processor is further coupled to a monitor for displaying images. User interface 40 interacts with the control processor and the display monitor. The control processor may also be coupled to a remote connectivity subsystem 42 comprising a web server 44 and a remote connectivity interface 46. Processing subsystem may be further coupled to data repository 48 to receive ultrasound image data. The data repository interacts with image workstation 50.

The architectures and modules may be dedicated hardware elements such as circuit boards with digital signal processors or may be software running on a general purpose computer or processor such as a commercial, off-the-shelf PC. The various architectures and modules may be combined or separated according to various embodiments of the invention.

In the acquisition subsystem 10, the transducer array 18 is in contact with subject 18. The transducer array is coupled to the transmit/receive (T/R) switching circuitry 20. The T/R switching circuitry 20 is coupled to the output of transmitter 22 and the input of receiver 24. The output of receiver 24 is an input to beamformer 26. Beamformer 26 is further coupled to the input of transmitter 22, and to the input of demodulator 30. The beam former is also coupled to the control processor as shown in the figure.

In processing subsystem 14, the output of demodulator 30 is coupled to an input of imaging mode processor 32. Control processor interfaces to imaging mode processor 32, scan converter 34 and to display processor 36. An output of imaging mode processor 32 is coupled to an input of scan converter 34. An output of scan converter 34 is coupled to an input of display processor 36. The output of display processor 36 is coupled to monitor 38.

Ultrasound system 10 transmits ultrasound energy into subject 16 and receives and processes backscattered ultrasound signals from the subject to create and display an image. To generate a transmitted beam of ultrasound energy, the control processor 28 sends command data to the beamformer 26 to generate transmit parameters to create a beam of a desired shape originating from a certain point at the surface of the transducer array 18 at a desired steering angle. The transmit parameters are sent from the beamformer 26 to the transmitter 22. The transmitter 22 uses the transmit parameters to properly encode transmit signals to be sent to the transducer array 18 through the T/R switching circuitry 20. The transmit signals are set at certain levels and phases with respect to each other and are provided to individual transducer elements of the transducer array 18. The transmit signals excite the transducer elements to emit ultrasound waves with the same phase and level relationships. As a result, a transmitted beam of ultrasound energy is formed in a subject within a scan plane along a scan line when the transducer array 18 is acoustically coupled to the subject by using, for example, ultrasound gel. The process is known as electronic scanning.

The transducer array 18 is a two-way transducer. When ultrasound waves are transmitted into a subject, the ultrasound waves are backscattered off the tissue and blood samples within the structure. The transducer array 18 receives the backscattered waves at different times, depending on the distance into the tissue they return from and the angle with respect to the surface of the transducer array 18 at which they return. The transducer elements are responsive to the backscattered waves and convert the ultrasound energy from the backscattered waves into electrical signals.

The received electrical signals are routed through the T/R switching circuitry 20 to the receiver 24. The receiver 24 amplifies and digitizes the received signals and provides other functions such as gain compensation. The digitized received signals correspond to the backscattered waves received by each transducer element at various times and preserve the amplitude and phase information of the backscattered waves.

The digitized received signals are sent to beamformer 26. The control processor 28 sends command data to beamformer 26. Beamformer 26 uses the command data to form a receive beam originating from a point on the surface of transducer array 18 at a steering angle typically corresponding to the point and steering angle of the previous ultrasound beam transmitted along a scan line. The beamformer 26 operates on the appropriate received signals by performing time delaying and focusing, according to the instructions of the command data from the control processor 28, to create received beam signals corresponding to sample volumes along a scan line in the scan plane within the subject. The phase, amplitude, and timing information of the received signals from the various transducer elements is used to create the received beam signals.

The received beam signals are sent to processing subsystem 14. Demodulator 30 demodulates the received beam signals to create pairs of I and Q demodulated data values corresponding to sample volumes within the scan plane. Demodulation is accomplished by comparing the phase and amplitude of the received beam signals to a reference frequency. The I and Q demodulated data values preserve the phase and amplitude information of the received signals.

The demodulated data is transferred to imaging mode processor 32. Imaging mode processor 32 uses parameter estimation techniques to generate imaging parameter values from the demodulated data in scan sequence format. The imaging parameters may comprise parameters corresponding to various possible imaging modes such as, for example, B-mode, color velocity mode, spectral Doppler mode, and tissue velocity imaging mode. The imaging parameter values are passed to scan converter 34. Scan converter 34 processes the parameter data by performing a translation from scan sequence format to display format. The translation includes performing interpolation operations on the parameter data to create display pixel data in the display format.

The scan converted pixel data is sent to display processor 36 to perform any final spatial or temporal filtering of the scan converted pixel data, to apply grayscale or color to the scan converted pixel data, and to convert the digital pixel data to analog data for display on monitor 38. The user interface 40 interacts with the control processor 28 based on the data displayed on monitor 38.

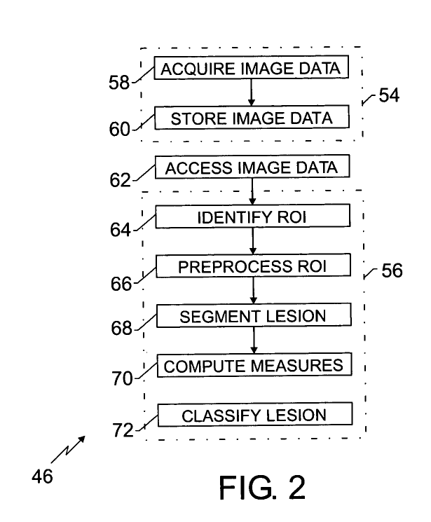

FIG. 2 is a flow chart illustrating a method for determining a plurality of characteristics of a breast lesion based on images acquired via a system such as that shown in FIG. 1. The flow chart comprises of two main sequences or phases, which are the acquisition sequence 54 and the processing sequence 56. Each step of these sequences, shown in the flow chart, is described in detail below.

The acquisition sequence 52 includes acquiring the image data as shown in step 58, such as through operation of the ultrasound imaging system described above with reference to FIG. 1. The image can be processed in real time or from a data repository. Accordingly, in step 60, the acquired image data is stored for later access and processing, such as for detection and classification of lesions or other growths.

The processing step comprises multiple substeps. In step 64, a region of interest in an image is automatically identified. In one embodiment, the region of interest is identified by using an inverted trough method. The inverted trough method identifies a rectangular region of an image that contains medical data by summing the pixel values of the each row of the image and identifying a trough in the two dimensional distribution of pixel values. Similarly, the pixel values of each column are summed up and a corresponding trough is determined. In this embodiment, the common area of a back projected rectangle determines the region of interest, although other techniques may also be suitable for such determinations.

In step 66, the region of interest is preprocessed to enhance the quality of the image. In one embodiment, an edge preserving smoothing filter is used to enhance the quality of the image. In one embodiment, a fuzzy enhancement technique is used to avoid saturation of bright regions and dark regions on the image. In addition, multi-scale morphology can be used to remove speckles in the image.

In step 68, the breast lesion is automatically segmented in the region of interest. In one embodiment, the gray level distribution is viewed as a 3-D plot. The 3-D plot typically comprises regions above a threshold value called “hills” and regions below the threshold value called “valleys”. The threshold value is determined based on the histogram of the region being analyzed. When the topology of the image is chopped at the level of the threshold, several holes remain within larger areas. Several isolated islands are also formed. The isolated islands are eliminated from processing. The image is further enhanced using morphological operations to fill small holes. In one embodiment, a connected component region growing approach is used to estimate a region of interest in the image. In a further embodiment, the biggest region formed using the connected component region approach is selected as the main lesion in the image. The initial contour for the region of interest is further analyzed to determine a more accurate approximation of the lesion boundary. As will be appreciated by those skilled in the art, a number of techniques are available for such boundary identification and segmentation.

In step 70, a plurality of measurements is measured for determining the plurality of characteristics of the breast lesion. In one embodiment, an inner rectangle is determined in the lesion for gray value calculations. For calculating posterior echo properties, the inner rectangle, an outer rectangle and a posterior rectangle are automatically calculated based on the dimensions of the lesion. In a further embodiment, a plurality of shape measurements, such as aspect ratio of the lesion, compactness of the lesion, regularity of the lesion boundary, margin characteristics and fuzziness of the lesion boundary are measured. The shape characteristics are described in further detail below.

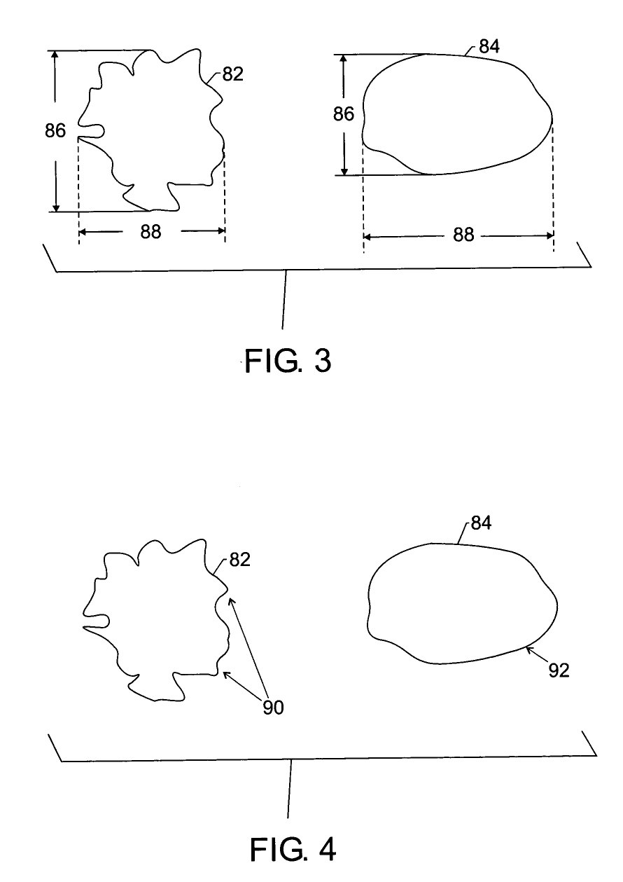

The aspect ratio of the lesion is defined as the ratio of the width of the lesion to the length of the lesion. In a present embodiment, the ratio of a major axis to a minor axis of an ellipse best fit to the lesion is used to determine the aspect ratio. Benign lesions usually have a lower aspect ratio compared to malignant lesions. FIG. 3 illustrates the manner in which aspect ratio is measured for malignant lesion 82 and benign lesion 84. The height of the lesion is indicated by reference numeral 86 and width by reference numeral 88. In general, if the aspect ratio is greater than 1, the lesion may be classified as malignant, but may otherwise be classified as benign.

Regularity of the lesion boundary can also be used to determine whether the lesion is benign or malignant. Typically, benign lesions have a smooth boundary while malignant lesions have an ill defined boundary. In a present embodiment, the frequency components of the contour of the lesion are used to determine the regularity of the lesion boundary. The regularity of the lesion boundary is illustrated in FIG. 4. The malignant lesion 82 demonstrates irregular boundary 90 whereas the benign lesion 84 displays smooth boundary 92.

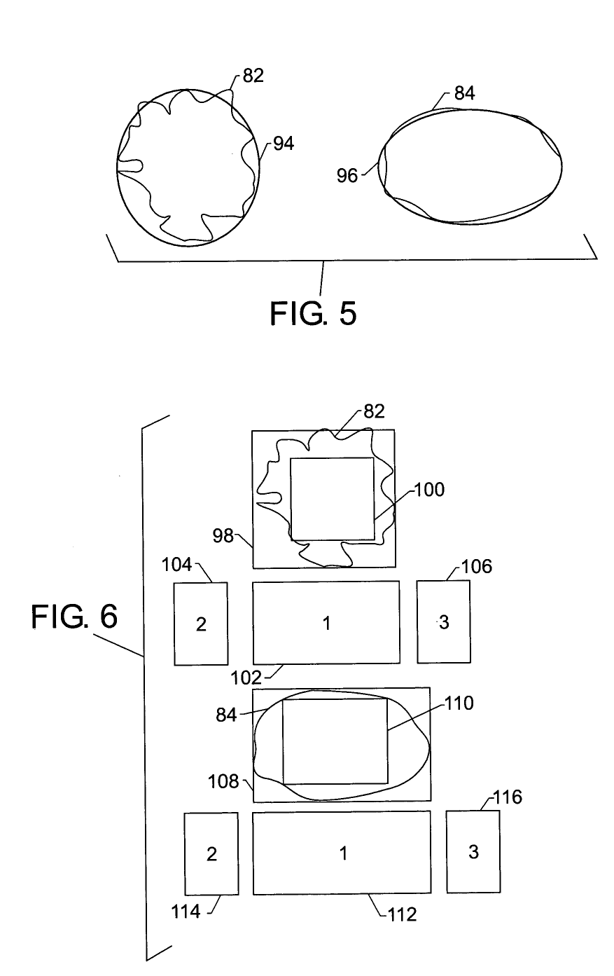

Compactness of the lesion is defined by the ratio of the area of the lesion to the best fit ellipse within the lesion. In general, benign lesions are more compact than malignant lesions. FIG. 5 illustrates the variation of the best fit ellipse 94 from the malignant lesion 82 and benign lesion 84.

Margin characteristics can also be used for determining the severity of the lesion. In one specific embodiment, the margin characteristics can be determined by analyzing data around the lesion with a Gabor filter in orientations from 0 to 360 degrees at an optimal scale of 4.

Fuzziness of the lesion boundary can also be used to distinguish between benign and malignant lesions. Hypo-echoic lesions exhibit a sharp transition in gray levels from inside the lesion to outside. Such hypo-echoic lesions indicate malignancy. In one embodiment, a line profile of gray values from within the lesion across the lesion boundary is generated. The least r-squared value of the line profiles is accumulated for all points on the lesion boundary and a measure is obtained to determine the relative fuzziness of the boundary.

Posterior echo measurements can be used to classify the breast lesion as benign or malignant. FIG. 6 shows the maximum bounding rectangle 98 and maximum internal rectangle 100 for malignant lesion 82. FIG. 6 also illustrates maximum bounding rectangle 108 and maximum internal rectangle 110 for malignant lesion 84. As used herein, maximum bounding rectangle refers to the rectangle that completely encloses the lesion contour externally and maximum internal rectangle refers to the maximum rectangle that just fits in completely into the interior of the lesion contour. Rectangle 102 and 112 correspond to rectangles with width equal to the width of the lesion, and existing just behind the lesion. In one embodiment, the distance behind the lesion and the height of the rectangle is dependent on the space left behind the lesion in the ultrasound image under consideration. Rectangles 104 and 114 correspond to rectangles with height equal to the height of rectangles 102 and 112, respectively, and located to the left of rectangle 102 and 112. In one embodiment, the distance between the two rectangles (rectangles 102 and 104 or rectangles 112 and 114) and the width of the rectangle 104 and 114 is dependent on the space to the left of the lesion in the ultrasound image. Rectangles 106 and 116 correspond to rectangles with height equal to the height of rectangles 102 and 112 and located to the right of rectangle 102 and 112. In one embodiment, the distance between the two rectangles (rectangles 102 and 106 or rectangles 112 and 116) and the width of rectangle 106 and 116 is dependent on the space to the right of the lesion in the ultrasound image. Posterior echo measurements are calculated based on the ratio of the mean and variance of echo in rectangle 102 (and rectangle 112) and rectangle 100 (and rectangle 110) respectively. If the value of the ratio is approximately 1, the lesion may be classified as malignant. If the ratio is greater or equal to 3, the lesion is more likely benign.

Similarly, if the regularity measurement is greater than 30%, the lesion may be classified as malignant. Likewise, if the lesion is uniform and homogeneous, the lesion is more likely to be benign. Similarly, if the fuzziness of the boundary is greater than 50% the lesion is likely to be malignant. Also, if the lesion has a margin, the lesion is more likely benign, and if the lesion compactness is greater than 70%, the lesion is more likely benign.

In step 72, the breast lesions are automatically classified as benign or malignant based on the plurality of measurements. In one embodiment, a rule-based system is used to classify the breast lesion. The rule based system applies a set of rules to classify the breast lesion. Examples of such rules include consideration of the measurements discussed above, including tall wide ratio or aspect ratio, posterior echo measurements, regularity measure, uniformity and homogeneity within the lesion, fuzziness of the boundary, presence of margin and compactness.

Some of the advantages provided by the foregoing techniques include a fully automated system ensuring greater productivity for a radiologist to detect and classify the breast lesion. The invention provides a measure of confidence of the possibility of the lesion abnormality being cancerous, while simultaneously listing out multiple features that were used to make the determination of the condition of the lesion. The invention also helps the radiologist to re-confirm diagnosis of a patient. It may also be noted that the method disclosed can apply to other lesions in the body whose characteristics correspond to the characteristics of breast lesions.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An automated method for determining a plurality of characteristics of a breast lesion, the method comprising:
automatically identifying a region of interest in an image, the region of interest comprising the breast lesion;
preprocessing the region of interest to enhance a quality of the image;
automatically segmenting the breast lesion in the region of interest;
automatically measuring a plurality of measurements for determining the plurality of characteristics of the breast lesion; and
automatically classifying the breast lesion as benign or malignant based on the plurality of measurements.

2. The method of claim 1, wherein the automatically measuring step comprises measuring a shape of the breast lesion based on a plurality of shape measurements.

3. The method of claim 2, wherein the plurality of shape measurements comprises at least one of aspect ratio of the lesion, compactness of the lesion, regularity of a boundary of the lesion, a plurality of margin characteristics, and fuzziness of the boundary of the lesion, wherein each of the plurality of shape measurements indicates the condition of the lesion.

4. The method of claim 3, wherein the plurality of shape measurements include more than one of aspect ratio of the lesion, compactness of the lesion, regularity of a boundary of the lesion, a plurality of margin characteristics, and fuzziness of the boundary of the lesion, wherein each of the plurality of shape measurements indicates the condition of the lesion.

5. The method of claim 1, wherein the classification of the lesion comprises a rule based system, the rule based system applying a plurality of pre-determined rules on the plurality of characteristics to indicate the condition of the lesion.

6. The method of claim 5, wherein the plurality of pre-determined rules include a tall wide ratio, posterior echo enhancement, posterior shadow, and regularity measure.

7. The method of claim 1, wherein the automatically segmenting step comprises generating a three-dimensional plot of the image; wherein the three-dimensional plot comprises a plurality of hills and valleys determined based upon a threshold value.

8. The method of claim 7, further comprising slicing a topology of the three-dimensional plot at the threshold value.

9. The method of claim 8, further comprising processing the three-dimensional plot to estimate the region of interest in the image.

10. The method of claim 1, wherein the identifying step comprises applying an inverted trough method to identify the region of interest.

11. The method of claim 1, wherein the preprocessing step comprises using an edge preserving smoothing filters.

12. The method of claim 1, further comprising applying a fuzzy enhancement technique to distinguish between a brighter region and a darker region.

13. The method of claim 1, further comprising applying a multi-scale morphology technique to remove speckles from the region of interest.

14. The method of claim 1, wherein the image is generated by an ultrasound system.

15. A system for determining a plurality of characteristics of a breast lesion, the system comprising:
a memory unit configured for storing an image;
a processor configured for automatically identifying a region of interest in the image, the region of interest comprising the breast lesion; the processor further configured for preprocessing the region of interest to enhance a quality of the image; automatically segmenting the breast lesion in the region of interest; automatically measuring a plurality of measurements for determining the plurality of characteristics of the breast lesion; and automatically classifying the breast lesion as benign or malignant based on the plurality of measurements.

16. The system of claim 15, wherein processor is further configured for measuring a shape of the breast lesion based on a plurality of shape measurements.

17. The system of claim 16, wherein the plurality of shape measurements comprises at least one of aspect ratio of the lesion, compactness of the lesion, regularity of a boundary of the lesion, a plurality of margin characteristics, and fuzziness of the boundary of the lesion, wherein each of the plurality of shape measurements indicates the condition of the lesion.

18. The system of claim 17, wherein the plurality of shape measurements include more than one of aspect ratio of the lesion, compactness of the lesion, regularity of a boundary of the lesion, a plurality of margin characteristics, and fuzziness of the boundary of the lesion, wherein each of the plurality of shape measurements indicates the condition of the lesion.

19. The system of claim 15, wherein the processor is further configured for applying a plurality of pre-determined rules on the plurality of characteristics to indicate the condition of the lesion.

20. The system of claim 19, wherein the plurality of pre-determined rules include a tall wide ratio, posterior echo enhancement, posterior shadow and regularity measure.

21. The system of claim 20, wherein the processor is further configured for generating a three-dimensional plot of the image; wherein the three-dimensional plot comprises a plurality of hills and valleys determined based upon a threshold value.

22. The system of claim 21, wherein the processor is further configured for slicing a topology of the three-dimensional plot at the threshold value.

23. The system of claim 22, wherein the processor is further configured for processing the three-dimensional plot to estimate the region of interest in the image.

24. The system of claim 15, wherein the processor is further configured for applying a trough system to identify the region of interest.

25. The system of claim 15, wherein the image is generated by an ultrasound system.

26. A computer-readable medium storing computer instructions for instructing a computer system to determining a plurality of characteristics of a breast lesion, the computer instructions including:
automatically identifying a region of interest in an image, the region of interest comprising the breast lesion;
preprocessing the region of interest to enhance a quality of the image;
automatically segmenting the breast lesion in the region of interest;
automatically measuring a plurality of measurements for determining the plurality of characteristics of the breast lesion; and
automatically classifying the breast lesion as benign or malignant based on the plurality of measurements.

27. An system for determining a plurality of characteristics of a breast lesion, the system comprising:
means for automatically identifying a region of interest in an image, the region of interest comprising the breast lesion;
means for preprocessing the region of interest to enhance a quality of the image;
means for automatically segmenting the breast lesion in the region of interest;
means for automatically measuring a plurality of measurements for determining the plurality of characteristics of the breast lesion; and
means for automatically classifying the breast lesion as benign or malignant based on the plurality of measurements.
